(19) United States
(12) Patent Application Publication
(10) Pub. No.: US 2008/0124690 A1
(43) Pub. Date: May 29, 2008

(54) TRAINING SYSTEM USING AN INTERACTIVE PROMPT CHARACTER

(75) Inventor: Sanford Redlich, Sausalito, CA (US)

Correspondence Address: Trellis Intellectual Property Law Group, PC, 1900 EMBARCADERO ROAD, SUITE 109, PALO ALTO, CA, 94303, US

(73) Assignee: Attune Interactive, Inc., Sausalito, CA (US)

(21) Appl. No.: 11/946,784

(22) Filed: Nov. 28, 2007

Related U.S. Application Data
(60) Provisional application No. 60/867,579, filed on Nov. 28, 2006.
(60) Provisional application No. 60/896,494, filed on Mar. 22, 2007.

(51) Int. Cl. G09B 19/00

(52) U.S. Cl. 434/236; 434/322

(57) ABSTRACT

A training program is provided that allows automated asynchronous role-play. In one embodiment, a trainee participates in an emotional face-to-face interaction with a prompt character delivering a challenge intended to prompt user reaction, followed by a simulation of that prompt character actively listening to the trainee's response. The prompt character, in both a challenge mode and an active listener mode may be displayed as video taken of a trainer or as an avatar.

### CROSS REFERENCES TO RELATED APPLICATIONS

This application claims priority from U.S. Provisional Patent Application Ser. No. 60/867,579, entitled “TRAINING SYSTEM”, filed on Nov. 28, 2006 U.S. Provisional Patent Application Ser. No. 60/896,494, entitled “TRAINING SYSTEM”, filed Mar. 22, 2007, which are hereby incorporated by reference as if set forth in full in this application for all purposes.

### BACKGROUND

Particular embodiments generally relate to training systems.

Training is very important to the ultimate success of companies and their employees. One training method uses the traditional classroom where a teacher leads a class of trainees. Providing the classroom training requires organization effort and cost. For example, costs include room and board, travel, entertainment, salary, and lost productivity due to trainees' absence from their desks. In fact, most training dollars are spent on overhead and not the training expenses. That is, the expense of training materials, the trainer's salary, and rent is dwarfed by the overhead of travel, hotel, food, and pay for trainees' while they are in the training class.

Other methods of training may also be used, such as online self-study. This may involve the use of slides and/or tutorials. In this case, users may review pre-written slides. Often, a trainee loses interest because it is a one-way communication. That is, the trainee is just reading slides. This method often does not provide adequate training to the user.

### SUMMARY

Particular embodiments generally relate to an interactive training system.

A training program is provided that allows automated asynchronous role-play. In one embodiment, a trainee participates in an emotional face-to-face interaction with a prompt character delivering a challenge intended to prompt user reaction, followed by a simulation of that prompt character actively listening to the trainee's response. The prompt character, in both a challenge mode and an active listener mode may be displayed as video taken of a trainer or as an avatar.

The prompt character creates an environment in which the trainee feels like they are talking with an actual human being so that the trainee may emotionally respond as if the situation were a real-world conversation. The prompt character may be used during a challenge (challenge mode) and/or response (active listening mode). For example, the prompt character may speak the challenge and then actively listen to the response. The prompt character may be generated based on behavior information, which may include the behavior of the trainer in the challenge recording, the behavior of the trainer in past trainer recordings, the behavior of the trainee during the response, the behavior of the trainee in the past, and previously stored typical human expressive behaviors. For example, if an angry challenge is desired, the trainer would act in an angry manner while recording the challenge. This angry behavior may then be detected and used to generate the prompt character in active listener mode with an angry demeanor.

During the response, recordings of the trainer or trainee's past behaviors may be analyzed to provide gesture characteristics of desired emotions such as anger or curiosity and these characteristic gestures may be played back during the prompt character's active listening mode. Real-time user behavior during the response may be similarly analyzed and used to determine appropriate reactions on the part of the trainer character's active listener mode. Examples of data used for behavioral analysis include audio frequency and amplitude, gesture tracking, user feature tracking, emotional state tracking, eye contact tracking, or other data which can be used to determine a user's behavior. Thus, the created prompt character behaves appropriately to create an emotional face-to-face interaction with the trainee. This engages the trainee during the training session.

In one example, the prompt character in challenge mode may recite a question. While the trainee is responding, the prompt character, in active listener mode, appears to listen to the response. The prompt character may change behavior based on detected user behavior. For example, if a trainee changes his/her eye level, the prompt character may adjust his/her eye gaze angle to continue to look the trainee in the eye. If the user pauses in speech, the prompt character may tilt its head inquiringly, prompting the user to continue, as a real person would. A response to the question may then be received from the trainee wherein the trainee behaves naturally because the simulation of a conversation with a real person is emotionally effective. The challenge and response may then be stored. This allows other users to view the challenge and response, which may be used for further training purposes or other review. For example, the trainee's supervisor may review the challenge and response to determine how the trainee is performing. The review is more representative of the trainee's normal behavior if the simulation of a real conversation is emotionally effective.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts an example of a training system for providing a training program according to one embodiment.

FIG. 2 depicts an example of an interface showing a training program according to one embodiment.

FIG. 3 depicts a simplified flowchart for creating a training program according to one embodiment.

FIG. 4 depicts a simplified flowchart of a method for processing content to create a challenge according to one embodiment.

FIG. 5 depicts a simplified flowchart of a method for providing a training program according to one embodiment.

FIG. 6 depicts a simplified flowchart 600 of a method for actively listening according to one embodiment.

FIG. 7 shows a more detailed example of devices in the training system according to one embodiment.

### DETAILED DESCRIPTION OF EMBODIMENTS

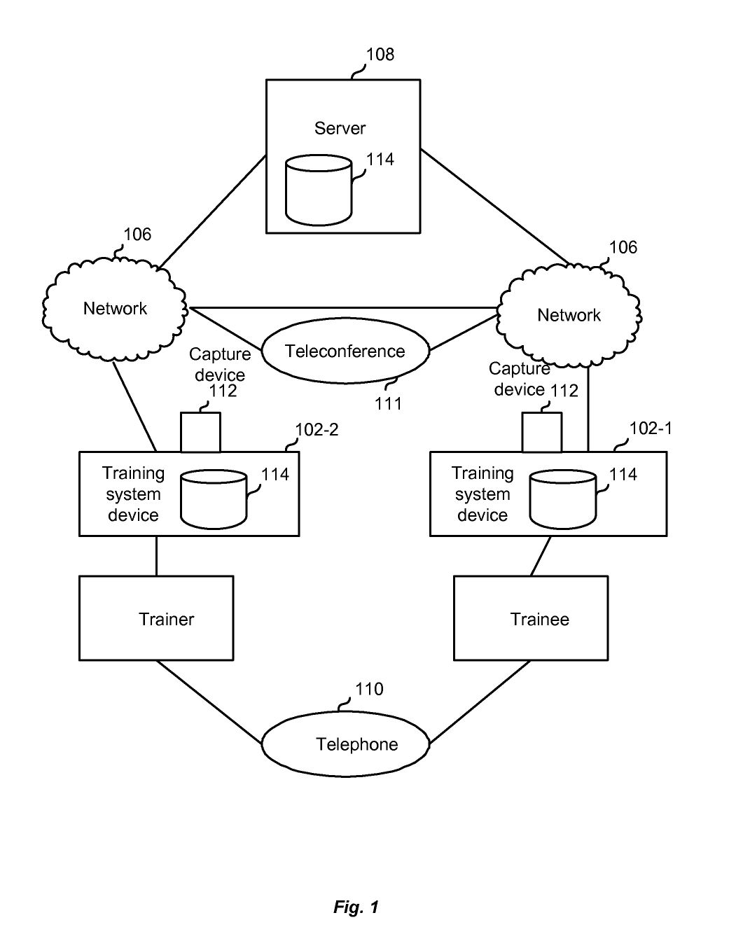

FIG. 1 depicts an example of a training system for providing a training program according to one embodiment. A training program is provided that uses a challenge and response format. The training program may be instructing a trainee in any subject matter. For example, the training may be for a job, for a class at school, for learning safety procedures, etc.

A first training system device 102-1 may be used by trainee to participate in a training program. A second training system device 102-2 may also be operated by a trainer. Other training system devices may also be used, but are not shown. Training system devices 102 may include a computing device that can communicate through networks 106 and examples include a desktop personal computer, a laptop personal computer, smart phones, cellular phones, work stations, set top boxes including televisions, or other suitable networked devices. Devices 102 may communicate through a network 106, which may include a server 108. Networks 106 may include wireless and/or wired networks, such as the Internet, a local area network (LAN), a wide area network (WAN), and a cellular network.

A trainer and trainee use the training system. The trainer and trainee may be described as taking particular actions. In some cases, the roles may be reversed. Thus, when trainer and trainee are described, it should be understood that when the trainee and/or trainer are being referred to, they may be the same user, a different user, or multiple combinations of users. The trainer and trainee may use network communication such as teleconference 111 or a telephone 110 to participate in a teleconference. This allows real-time interaction between the trainee and trainer allowing the trainee to speak with a trainer during the training session.

Training system devices 102 may include capture devices 112 that can record aspects of a trainee's or trainer's behavior. For example, video, audio, motion, infrared radiation, active infrared radiation, heart rate, blood pressure, hand squeeze pressure, electroencephalogram and/or galvanic skin resistance, or other recorded information may be captured. Examples of capture devices 112 include cameras, video recorders, infrared recorders, infrared cameras, visible light cameras, etc. Other components of training system devices 102 may also be included and will be described in more detail below.

The trainee can interact with device 102-1 to participate in a training program. Content for the training program may be stored in storage 114. Storage 114 may be included in various locations and may be distributed. For example, storage 114 may be found in device 102-1, server 108, and/or device 102-2. The content may be transmitted through networks 106 if it is stored on server 108 or device 102-2. The data itself may be in any format including extensible markup language (XML), Adobe flash video, MP3 audio, MPEG video, or other storage formats.

The training program provides a prompt character with which a trainee can interact. The prompt character may be in the form of captured video of a person or in the form of an avatar. The trainee participates in a challenge/response model of a training program. For example, the prompt character in challenge mode would ask a challenge to which the trainee needs to respond by speaking, just as in a real-life dialogue. The challenge may be a stimulus or prompt (e.g., a question or statement) that is intended to elicit a response from the trainee. The challenge may be created by a trainer, which may be a human user or machine. The trainee may be a human user or machine that responds to the challenge. The prompt character operates in two modes: challenge mode and active listener mode. The prompt character issues the challenge in challenge mode. After the challenge has been issued, the prompt character enters active listener mode, appearing to listen to the trainee's response while exhibiting typical human listening behaviors. The trainee may respond more naturally to the challenge while speaking with a human-acting active listener, as he or she would in real life. Other models of training programs may exist, such as multiple prompt characters asking questions in series or parallel, e.g., interrupting each other.

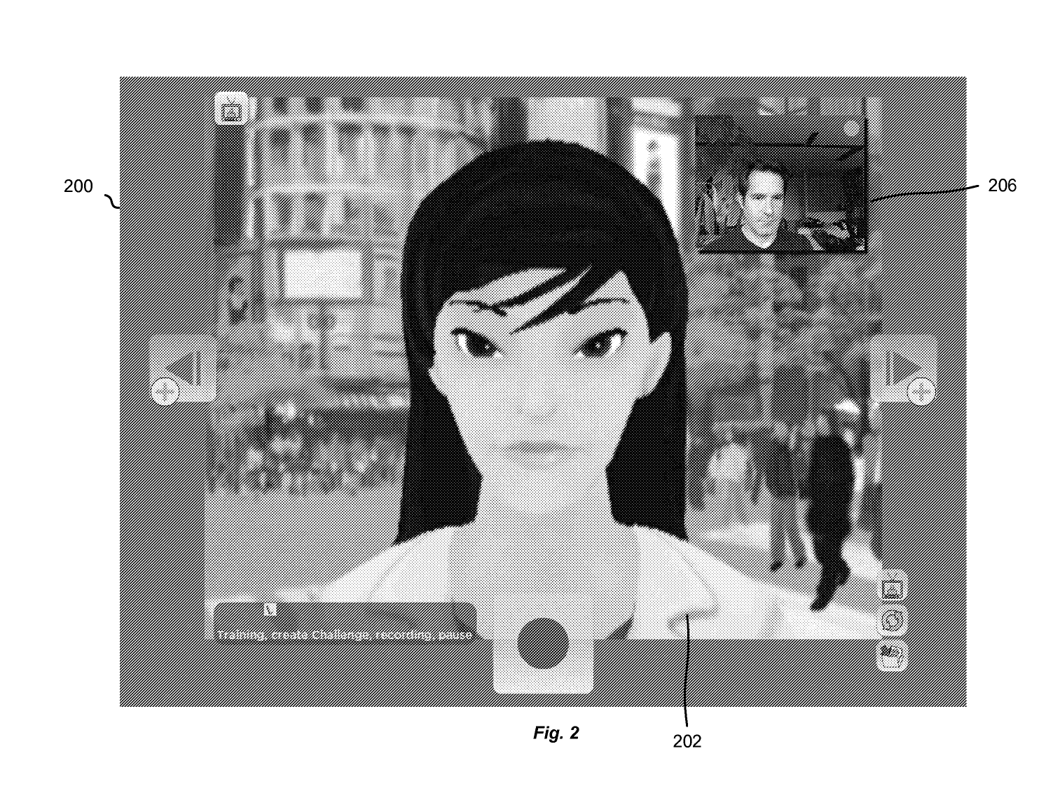

FIG. 2 depicts an example of an interface 200 showing a training program according to one embodiment. As shown, a prompt character 202 is provided on a display screen 204. Prompt character 202 can be a video or an avatar of a trainer. Also, a window 206 shows video of the trainee. Thus, as a trainee is outputting the response, it may be recorded and shown in window 206.

Prompt character 202 may be video recorded of a trainee. The video may be later processed and output as the challenge.

Prompt character 202 may be an avatar, which may be an animated character. The avatar may take any form, from that of a cartoon character to a realistic representation of a trainer.

In one embodiment, to achieve the avatar, a 3-dimensional model of a user's appearance may be created for any part of the user and the 3-dimensional model is then animated. This may be referred to as a scanned avatar. The 3-dimension model may be created by comparing multiple images of a user in different poses and inferring a 3-dimensional shape of the user. Also, a user may alternatively choose an avatar from a standard, pre-defined set or customize a pre-defined avatar by combining standard pre-defined features, such as face shapes, facial hair, colors, jewelry, and clothing.

Actions for prompt character 202 may be determined based on behavior information, which may be information that is determined based on human behavior. The behavior information may be determined by receiving a recording of the trainer/trainee, determining positional information for features in the recording, and then determining subject state information (e.g., an emotional state).

The recording may be of the trainer, the trainee, and other people whose behavior has been recorded and stored in a library of typical human expressive behaviors.

The positional data may be kinetic metadata, which may be movement metadata describing movement of features. The positional data may be extracted at intervals from the recordings and stored over time. For example, the position in space of specific body parts such as lips, eyes, eyebrows, hands, or feet may be extracted by analyzing the recorded behaviors.

The subject state may then be determined from the movement data. For example, certain movements of features infer different subject state. For example, behaviors may include vocalizations, eye contact, smiles, frowns, eye blinks, hand gestures, and other recordable behavior. Metadata may be extracted for subject emotional state, rapidity of speech, patterns of gestures, and patterns of amplitude change in the audio information.

The subject state may be an emotional state that is inferred from video captured of a trainer based on changes in the user's eye focus, gaze direction, facial expressions, head pose changes, hand motion, or other user behavior. Also, emotional information may be inferred from a trainer's tonal qualities. Emotional state may also be used in other ways such as to guide the training program into different sequences of challenges.

The behavior information may include different actions that represent different behaviors. The actions that are determined may depend on the subject state that is determined. For example, if an angry state is determined, the action is a frown.

In one embodiment, it is desirable for simulated behaviors of prompt character 202 to be typical of the behaviors of a trainer that made the challenge in addition to the kind of situation to which the challenge is being presented. In one embodiment, gesture tracking, audio tracking and content metadata may be used to determine behavior information. In the following description, the trainer is used as an example for determining the behavior information. However, the behavior information may be determined while the trainee is responding and used to dynamically alter prompt character 202. Thus, when trainer is mentioned below, it will be understood that similar processes may be used with the trainee.

Gesture tracking may track movements of a recorded trainer's facial features and/or body. Tracked gestures may include head poses, facial expressions, lip movements, eye gaze, hand gestures, limb gestures, or other gestures made by a user. The gesture tracking may be analyzed from video captured of a trainer's response. A trainer may optionally increase tracking accuracy by training the system to recognize a trainer's facial features in various positions. This is done by having a trainer move through a series of set poses, where the location of particular facial features is marked. For example, the corner of the eye may be marked in video such that eye movements of a user can be tracked. A gesture tracking system may be a visible light-based and/or an infrared-based tracking system.

Audio tracking may analyze the audio of a content element to determine behavior information. In this case, characteristics of audio, such as amplitude, state, key words or key phrases, identification of particular phonemes, other audio cues may be used to determine user behavior information. For example, if the amplitude of a trainer's voice goes above or below a certain threshold, then certain behavior may be inferred. For example, if the amplitude is above the threshold, it may be inferred that the user is angry. Similarly, sequences of behaviors may identify behavioral information, such as having high audio amplitude followed by low amplitude to indicate an emphatic ending to a response.

The environment of the challenge may also be used as behavior information. For example, if a challenge is meant to be funny, then the prompt character may display a happier facial expression or a facial expression of an avatar laughing.

Prompt character 202 is rendered more natural in its behavior because its behavior is generated using data derived from real human behavior. Timing may be crucial to the appearance of a natural character, for example the timing of the prompt character's facial gestures should match the tone and content of what the prompt character is saying. Timing may be similarly crucial to the appearance of a natural dialog. The prompt character in active listener mode should respond to the trainee's behavior with the correct gestures executed at the correct time in order to create a simulated dialog which feels natural. Because the prompt character may include aspects of trainer behavior, the trainee may feel that the prompt character is a natural continuation of the trainer character's behavior in challenge mode. The trainee may feel that he/she is being actively engaged in the training session. Thus, when a challenge is presented, the trainee may feel like the prompt character is actually another person. The trainee may then respond in a natural manner to the challenge question. During the response, the prompt character may appear to listen to the response by exhibiting some behavior, such as reacting to determined trainee emotional state and/or the content of trainee speech as determined by voice recognition analysis. For example, user behavior detected from the trainee may be used to alter the prompt character's behavior while listening to the response.

The behavior of prompt characters may also be triggered by a real-time trainer, for example to deliver a challenge and then display appropriate active listening behavior while the trainer is free to observe the trainee.

In the training program, prompt character 202 may first pose a challenge. The challenge may be a question, statement or other information intended to elicit a response from the trainee. Also, in other embodiments, the challenge may be a statement that does not require a response from the trainee. Trainee behavior information may be dynamically used to alter the image of prompt character 202 based on the current environment of the training session (such as during the response mode). In one example, the eye gaze of the trainee may be detected using video captured by capture device 112. Then, the eye gaze of prompt character 202 may be adjusted to look the trainee in the eye. Accordingly, when the challenge is output or a response is received, prompt character 202 may appear to maintain eye contact with the trainee. Other examples of modifying prompt character behavior based on trainee behavior will be described in more detail below.

As the trainee responds to the challenge, the response may be captured. For example, video of the trainee's response may be captured using capture device 112. Also, audio or any other information may be captured from the response.

The response may be stored and associated with the challenge. A collaborative training program is provided in which the challenge and different trainees' responses are stored in the collaborative training program. Other trainees can then review various trainees' responses to a given challenge. Accordingly, the collaborative training program may grow as more trainees respond to the challenges. This may be a useful tool for training as preferred training responses can be reviewed by other trainees. Also, supervisors or other users may review a trainee's responses for other reasons, such as to monitor a trainee's progress.

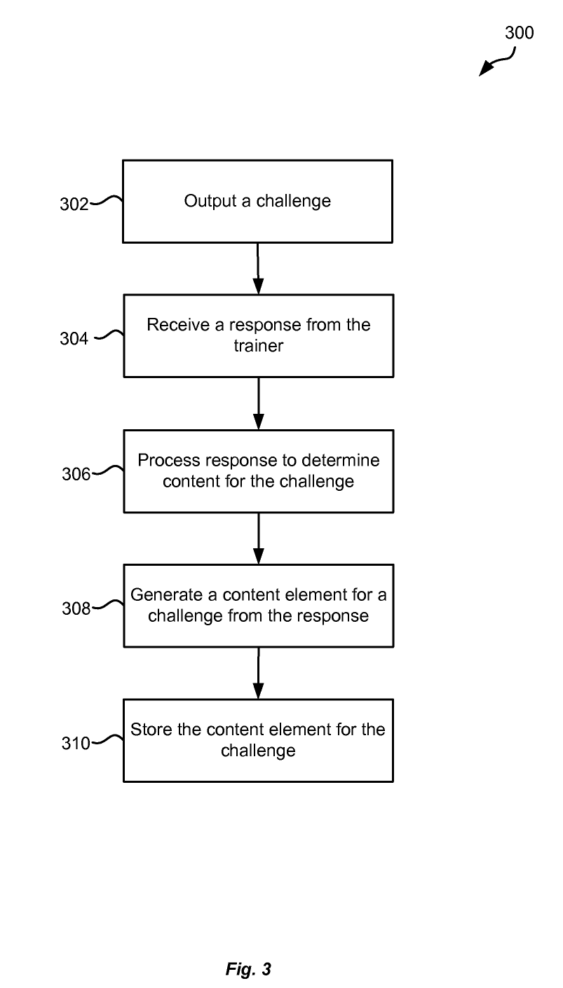

The process of creating a training program, processing content for the training program and the execution of the training program will now be described in more detail. FIG. 3 depicts a simplified flowchart 300 for creating a single training program challenge according to one embodiment. The training program may be created using device 102-2. In one embodiment, to create the training program, the trainer participates in a challenge/response method just as the trainee participates in. In this case, prompt character 202 may output a challenge and the trainer would respond to the challenge while the prompt character displays active listening behavior. The trainer's response is then processed to create a new challenge that is then added to the training program. Although this method is described, it will be understood that other methods of creating a training program will be appreciated. For example, a user may type or speak challenge questions without being prompted by prompt character 202.

In step 302, prompt character 202, in challenge mode, outputs a challenge. The challenge may be a question that is intended to elicit a response from the trainer for creating a challenge for the training program. For example, the challenge may be: “What question would you like to ask the trainee?”

Step 304 receives a response from the trainer. For example, capture device 112 may capture audio and/or video of the response from the trainer.

In step 306, the response may be processed to determine content characteristics for the challenge. For example, the beginning and end of user speech may be analyzed to determine the beginning and end point, respectively, of the content.

In step 308, a content element for a challenge is generated from the response. The challenge may be created in different ways using video and/or an avatar. In one example, the video recorded of the trainer responding to a challenge is used as the challenge.

Information for prompt character 202 is stored for the challenge. For example, metadata may be stored so that a prompt character 202 can be dynamically created during run-time in the challenge mode and the active listener mode. This metadata holds information derived from the capture device during step 306, such as the timing, motion, and magnitude of movements and expressions such as a smile, a raised eyebrow, or a hand wave. Also, prompt character 202 may be generated and stored. For example, the avatar is generated to output the challenge and stored.

In step 310, the content element for the challenge is stored. The content element may be a discrete unit of content out of content that is stored for a training program.

In one embodiment, a sequencing of challenges may be determined for a training program. A trainer or trainee can then establish a preferred sequence among content elements that have been stored for challenges. In one example, a user can be shown different content elements that are available for a training program and can then select different content elements in a sequence. Each content element can be assigned a sequence number for the training program. Links may be established between content elements to provide a sequence that outputs different challenges in the training programs in an order. Different groupings may be created for different training programs from stored challenges. In one embodiment, the content elements may be stored in different folders and organized by training program. To invoke a training program, a folder may be selected and challenges may be output according to the sequence that has been assigned to content elements.

Accordingly, the challenge/response method is used to create a training program. A response by a trainer to a challenge is processed to create a challenge for the training program. This provides a trainer with an interface to easily create a training program. Also, behavioral information may be captured from the trainer as the trainer responds to the challenge. As will be described below, the behavioral information may be used to create an emotional prompt character 202.

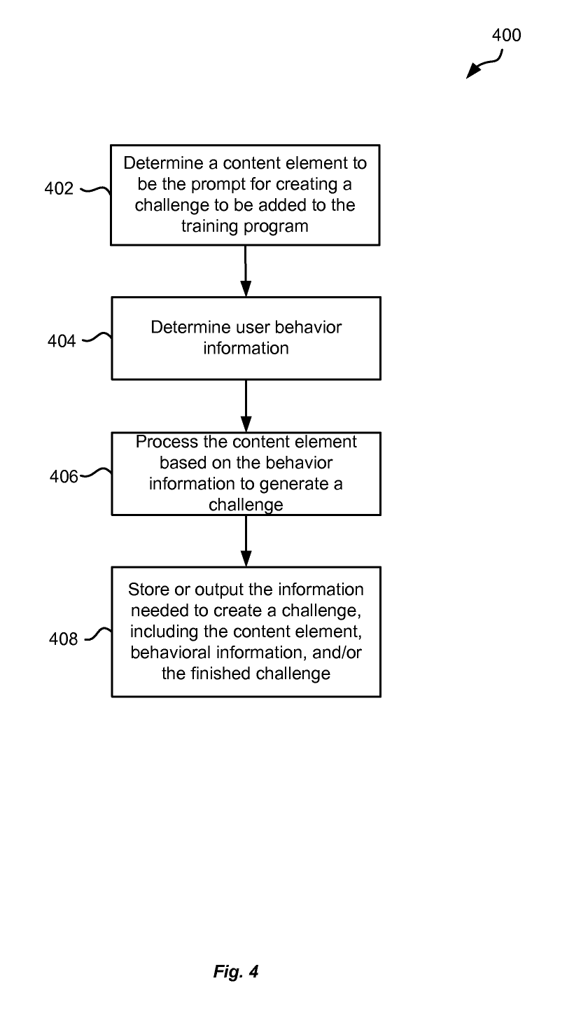

FIG. 4 depicts a simplified flowchart 400 of a method for processing content to create a challenge according to one embodiment. The following process may be used to create an avatar as prompt character 202. In other embodiments, the video captured may be used as the content element, such as certain aspects of the video may also be processed to reflect trainee behavior. For example, a user's expression or eye gaze direction in the video is altered. Step 402 determines a content element to be the prompt for creating a challenge to be added to the training program. The content element may be any portion of content. For example, video of a trainer may be captured and a portion of the video may be determined. This portion may be when a user is actively speaking. In one example, a continuous capture of video may be captured of a trainer and a portion of the content where the trainer is actively responding to the challenge question is determined.

Step 404 determines behavior information. The behavior information may be determined from the response received from the trainer that was used to create the challenge (e.g., the expressions or gestures of the trainer). Also, behavior information may be determined from other sources not related to the captured content, such as a trainer may want the challenge to have a specific emotional state, such as an angry, friendly, or other emotional state.

In some cases, behavior information may not be sufficient to simulate human behavior. For example, gesture tracking data may be incomplete and/or audio information may not provide accurate behavior information. In this case, behavior simulation may be performed to simulate a behavior. In one embodiment, a behavior that is determined to best match a recorded behavior may be determined. For example, gestures may be interpolated to determine a gesture that the trainer may most likely have been making.

In step 406, the content element is processed based on the behavior information to generate a challenge. For example, a prompt character 202 is created to output the challenge. In one example, an avatar is created to output the challenge included in the content element. The audio portion of the content element may be used to output the challenge question. The behavior information is then used to animate the avatar.

Step 408 stores or outputs the information needed to create a challenge, including the content element, behavioral information, and/or the finished challenge.

In one example, the behavior information may include particular trainer movements made during a response that is used to create the challenge. The trainer may be asked to exhibit the behavior that is desired of prompt character 202. If a defensive behavior is desired for the challenge, prompt character 202 may be an avatar speaking angrily that may be used to elicit defensive behavior. Behavior information may include typical defensive expression motions, such as eye narrowing or frowning. This information may be used to create a prompt character 202 with these expressions. If video is being analyzed for behavior information, the furrowing of a trainer's eyes may be detected as exhibiting an angry behavior. This may be noted during a time period of the content element. The end point of the behavior may be the trainer looking away, speaking, or smiling, and may indicate that the defensive expression motions have ended. The angry behavior may be ended in the content element when this is detected. By using behavior information detected from a user, precise movements may be simulated by prompt character 202. This includes the timing of the movements.

To appear natural, the timing of a person's expression should precisely correlate with the timing of the meaning and emotional modulation of his or her voice. For example, if an audio of a question is used and an avatar is simulated to include an angry expression, the simulation depends on programming the angry expression to appear and change over time to match the speaker's angry meaning and tone. This is achieved by simulating avatar behavior using data derived from recordings of the speaker's actual behavior while speaking, as described above. In contrast, if video of a trainer speaking is not used, then the avatar that is created may not be realistic to the trainee because the timing of the expressions and the speech may be off. For example, an animation algorithm may guess as to when expressions should be animated but a human may not think this is realistic. By using behavior information detected from video of a trainer speaking what will be used as the response, a scowl can be detected at the right time the trainer desires the scowl and the scowl expression can then be simulated realistically in time with the trainer's speech. In addition to reflecting behavior during the output of a response, behavior information may be used to simulate a trainer listening to the response when a trainee is responding to a challenge. This will be discussed in more detail below.

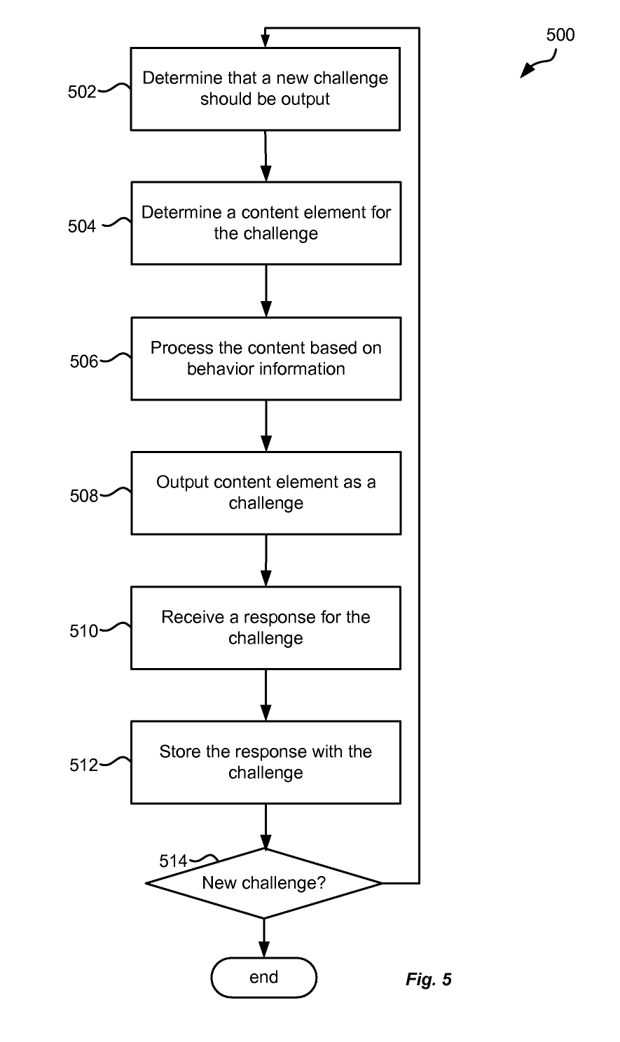

Once a content element for a challenge is stored, challenges may be linked together to create a training program. A trainee may then initiate the training program using device 102-1. FIG. 5 depicts a simplified flowchart 500 of a method for providing a training program according to one embodiment. In step 502, device 102-1 determines that a new challenge should be output. For example, cues may be used, such as video may be analyzed of a trainee to determine when a trainee stops speaking to determine when a new challenge should be output. In this case, the trainee may have responded to the prior challenge and is ready for a new challenge. Also, a trainee may select an icon to indicate a challenge should be output.

In step 504, device 102-1 determines a content element for the challenge. For example, a content element that represents a next challenge that should be output may be determined in the training program. The content element may be determined based on the sequencing that was configured for the training program. For example, a content element that is linked with the next sequence number may be determined.

In step 506, the content element may be processed based on behavior information. This behavior information may be behavior information that is detected from the trainee participating in the training program. For example, detected user behavior information of the trainee may be used to affect the behavior of prompt character 202. Also, if prompt character 202 was not already generated, then prompt character 202 is generated using the behavior information as described in FIG. 4. With respect to the detected behavior information from the trainee, dynamic processing of prompt character 202 may be provided to further generate a customized prompt character 202. As was discussed above, prompt character 202 was created using behavior information for the challenge without taking into account the specific trainee participating in the training program. However, behavior information that is detected while the training program is being executed may also be used.

In one example, eye contact simulation may be provided. In this case, the appearance of eye contact during the output of the challenge may be used to give the appearance that prompt character 202 is maintaining eye contact with the trainee. In one example, the avatar that is outputting the challenge may adjust his/her eye toward they eyes of the trainee. Also, if real video is being used, the video may be adjusted such that the user in the video maintains eye contact with the trainee.

To simulate user behavior, the current values of animation control points of the displayed prompt character 202 may be determined. The values of the animation control points may be adjusted over time based on the behavior information. For example, the eye gaze of prompt character 202 may be adjusted based on the eye position of the trainee.

To determine the gaze, capture device 112 records from a fixed point on device 102-1. For example, the fixed point may be relative to the center of display 104. If a first display is 100″ wide and 50″ tall and a second display is 1″ wide and 2″ tall, then each might record from a position of 30% of display height higher than the horizontal center line and 20% of the display width to the right of the vertical center line. However, software may be used to determine the eye level of a user wherever capture device 112 is mounted. Camera calibration may be used to determine a difference between the trainee's actual neutral gaze and what the trainee's gaze direction would be if the trainee were looking directly into the camera . . . This calibration may be performed by displaying a representation of a face having two eyes of any type with the eyes at a known position horizontally and vertically on display 204. The trainee is asked to look in the representation's eyes. Video is received of the trainee and face tracking is performed to determine a head pose orientation and eye gaze direction. The difference in horizontal and vertical angle of the user's actual gaze direction are stored for later use to adjust display elements to make it appear that the trainee was looking directly at the camera during recording. If the calibration is lost or rendered inaccurate, for example if light conditions change, tracking may be lost, and the user may have to go through the calibration procedure again. In this case, the user may be asked to recalibrate.

Continuous recalibration may also be performed. For example, when the trainee is talking with prompt character 202, the trainee may be looking near the face of prompt character 202 and may likely be most often looking in the direction of the eyes of prompt character 202. The head pose and eye gaze angles are then determined and stored and the most common head pose and/or eye gaze angles are then stored and used, as above, to calibrate the head pose and gaze of prompt character 202. For example, if, using the previously determined gaze angle, it appears that the user is looking consistently at a point away from the eyes of prompt character 202, then calibration may be determined to be off and needs to be corrected. In this case, additional eye tracking readings may be determined using one of the two above methods and a new eye gaze angle may be determined.

In step 508, the content element is output as a challenge. For example, prompt character 202 may output the challenge. In one embodiment, playback smoothing is provided. To simulate normal human conversation, if prompt character 202 appears in two sequentially-displayed content elements, it is desirable for the appearance of prompt character 202 to smoothly transition from that displayed at the end of the first content element to that displayed at the beginning of the second content element. That is, if the first piece of content element uses a prompt character 202 that outputs a challenge and ends in a first position, it is desirable that an image of prompt character 202 does not jerk or skip to a second position that is entirely different from the first position. This may occur because different content elements may have been sequenced together but were not recorded sequentially. For example, the trainee could have recorded challenges in any order and then re-sequenced them.

In one embodiment, using the avatar as an example, the avatar is animated from the first position at the end of the first content element and moved to the second position of the avatar at the beginning of the second content element. In one embodiment, the transition animation may be spread throughout the non-speaking time between content elements. This allows needed adjustments to be added to the ongoing natural user movements, thereby preserving lifelike appearance and avoiding the addition of unnecessary animation frames. For example, as the avatar is listening to a trainee's response, the avatar may be animated towards the position of the avatar at the beginning of the second content element.

In one example, if two content elements are scheduled for sequential display and the same prompt character is being used in each, then using audio metadata, the first time is determined at which speaking ends in the first content element and a second time at which speaking begins in the second content element is determined. At the first and second times, values of all animation control points, such as those controlling head poses and lip positions, are determined. The difference in values is determined and divided by the value of a number of animation frames between the first and second times to determine a movement value. In each animation frame between the first and second times, for each animation control point, the movement value is added to the animation. Accordingly, prompt character 202 may smoothly transition from the position at the end of the first content element to the position at the beginning of the second content element.

Also, during output of the challenge, talking points may be output. The talking points may include bullet points that may guide the trainee in what responses are needed.

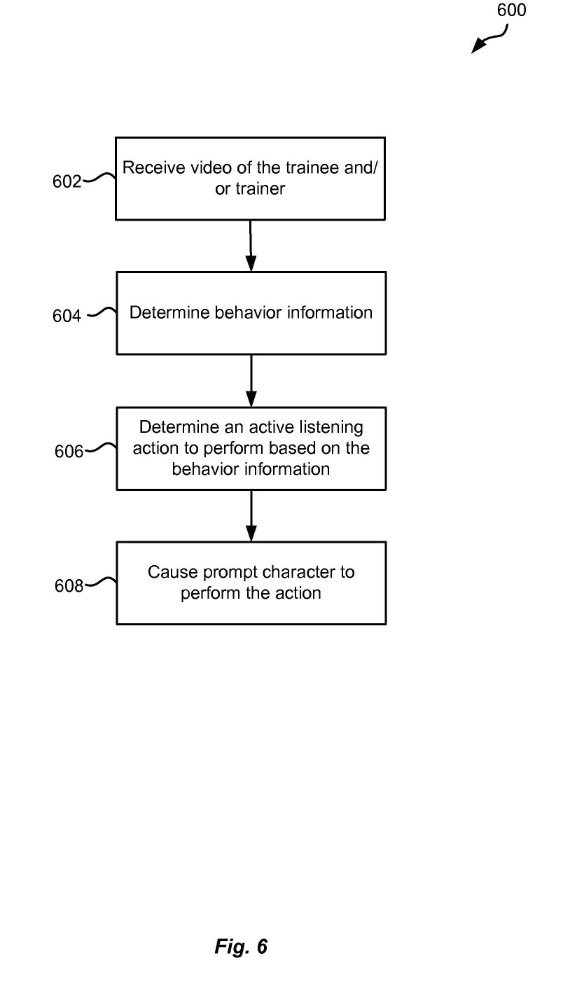

In step 510, a response is received for the challenge. The response may be shown on display 106 so that the trainee can see himself/herself. Also, user behavior information may be inferred from the response for use in generating a new challenge or providing active listening. For example, in step 512, active listening is simulated for prompt character 202 based on the detected behavior information. FIG. 6 depicts a simplified flowchart 600 of a method for actively listening according to one embodiment.

Step 602 receives video of the trainee and/or trainer. The video may be received in real-time while the trainee is responding to the challenge. Also, the video may be from before the trainee responds, such as past behaviors.

Step 604 determines behavior information. As mentioned above, the recordings of the trainer or trainee's past behaviors may be analyzed to determine behavior information, such as gesture characteristics of desired emotions such as anger or curiosity. Real-time behavior during the response may be similarly analyzed and used to determine behavior information. Examples of data used for behavioral analysis include audio frequency and amplitude, gesture tracking, user tracking, emotional state tracking, eye contact tracking, or other data which can be used to determine a user's behavior. For example, the amplitude of the trainee's speech may be monitored. Depending on changes to the amplitude, certain behaviors may be inferred. For example, an increase in the amplitude of the trainee's speech may indicate the trainee is angry.

Step 606 determines an active listening action to perform based on the behavior information. Step 608 then causes prompt character 202 to perform the action. The active listening action is meant to simulate real-world human behavior between a trainer and trainee. For example, the action may be to nod the head of prompt character 202 when a question is being spoken. Also, the eye level of prompt character 202 may change as the eye level of the trainee changes during the response. Also, if it is detected that the trainee is not responding or doing something else, prompt character 202 may cross his/her arms or perform another action to show that the user is not responding quickly enough. By simulating listening based on user behavior that is detected, it provides the appearance of human-to-human interaction. This may keep the interest of the trainee.

In one embodiment, the active listener action may be performed by an avatar or using video of the trainer. If video is used, actions for prompt character 202 may be represented in one or more recordings of the trainer who created the challenge. In one embodiment, a recording of the trainer behaving as if listening is used. To create it, the trainer is recorded while appearing to listen, starting from a neutral head position. The recording is then displayed in a loop during the trainee's response. In another embodiment, a set of recordings of the trainer is made, each showing the trainer displaying different expressive behaviors. This is achieved by instructing the trainer to mirror the behaviors of the prompt character, then recording the trainer while displaying a prompt character that is going through a series of typical listening behaviors, such as just listening and blinking, tilted head, nodding, or appearing skeptical. The prompt character comes back to a neutral head position each time. The recording is then split into separate content elements each representing a specific expressive behavior. The appropriate one of these is then displayed in response to the trainee's behavior. Thus, when an action is determined for prompt character 202, a recording of the trainer for the action is determined and displayed.

When an avatar is used, the actions may be customized to the avatar. For example, if the trainer who created the avatar smiles in a certain way, the avatar may smile in a way that is simulated to be similar to the way the trainer smiles. In other examples, the avatar may smile in the same way no matter which trainer created the avatar. Referring back to FIG. 5, step 512 then stores the response with the challenge. Accordingly, other users including the trainee may view the challenge and the response.

The end of the user's response may be determined and step 514 determines if a new challenge should be output. The end of a trainee's response may be used to determine when to output another challenge and/or to determine when to end recording of the user. For example, when a trainee responds, and stops talking, it is preferable that prompt character 202 then responds to the trainee without requiring the trainee to indicate that trainee is finished talking. This provides the trainee with the experience that he/she is conversing with a human more than if the trainee had to input when he/she is finished talking and wants to have a new challenge output.

Accordingly, training system device 102-1 determines when a trainee has finished speaking. To test whether a trainee has finished speaking, prompt character 202 waits for a pause and offers a prompt. The prompt may be in non-verbal forms, such as gestures, which include nodding of the head, tilting of the head, raising one or both eyebrows, or other gestures. Also, the prompt can be in verbal form, such as sounds that include “uh-huh”, “mm,” or “ah.” The prompt may also be in other verbal forms that include words such as “okay,” “yeah,” “well,” etc. These prompts may be referred to as social end point test prompts, issued to test whether the user has likely finished speaking. For example, if the trainee has finished speaking and a prompt is output, video of the trainee is monitored. If a desired response is received from the trainee, it may be determined the trainee is finished speaking. For example, if an eyebrow is raised, and the user does not continue to speak, then it may be determined that the user has finished speaking. The beginning of the trainee's reaction may be determined by monitoring average recorded audio amplitude. Whether the trainee continues speaking after a social end point test is determined by monitoring the average recorded audio amplitude. For example, if the audio amplitude rises above a pre-determined threshold longer than a pre-determined time period, then the user is determined to have continued speaking. If the audio amplitude does not rise above the threshold within a set time period, it is determined the user did not continue speaking. When it is detected that the user has stopped speaking, a new challenge may be output. In this case, the method may reiterate to step 502. The training session can also end when there are no more challenges.

A reaction beginning and pause beginning may also be used to trim the recording of a user. The reaction beginning may be determined if audio rises above a pre-determined threshold longer than a pre-determined time period. In an alternate method, speech recognition analysis may be used to identify a first spoken word and then the reaction beginning determined by the beginning of that word. The reaction end may be determined if audio stays below a pre-determined threshold for longer than a pre-determined time period. The training system may delete from the recording the time before the time of the reaction beginning and/or remove the time after the reaction end.

During the training session, an action board may be provided that allows a trainer to guide real time challenges being output to the user. The trainer can activate a challenge to which the trainee can react and also review the trainee's response. A view of the trainee can be displayed on device 102-2 such that the trainer can monitor and better guide the trainee. The action board allows the trainer to select a next challenge to output to the trainee, either immediately or added to a queue of challenges to be output. Also, the action board allows a specific user behavior to be dynamically used to create prompt character 202. For example, the trainer may want to inject an angry emotional state into prompt character 202 for the next challenge question.

Also, the training session may automatically drive the trainee to a desired emotional state. For example, user behavior may be imparted to prompt character 202 in an attempt to display emotion from prompt character 202. This is intended to invoke an emotional state from the trainee. The trainee's emotional state is then determined from behavioral information and used to determine new prompt character behavior intended to drive the trainee to a desired emotional state. For example, the training program author may determine that a target level of anger of 7 on a scale of 1-10 is desired for testing. While the trainee's emotional state is below level 7, the training session will present prompt characters behaving such that they provoke anger in the trainee to raise the trainee's anger level. If the determined trainee anger level exceeds 7, then the training session will present prompt characters behaving such that they provoke less anger or are soothing, to lower the trainee's anger level to the target level.

A collaborative training program may be provided. For example, when a challenge and response is recorded, a user may decide to have it stored in a training program. For example, a button may be provided on interface 100 that allows a user to store the recorded challenge and response. Later, the trainee's supervisor may review the challenge and response to grade the trainee. Also, other trainees may use the challenge and response for training purposes. For example, if the response is deemed to be an ideal response, other users can view the challenge and response as a demonstration. The challenge and response can be added to the training program using the sequential method described above. For example, a sequence number in the training program may be used to link the challenge/response into the training program.

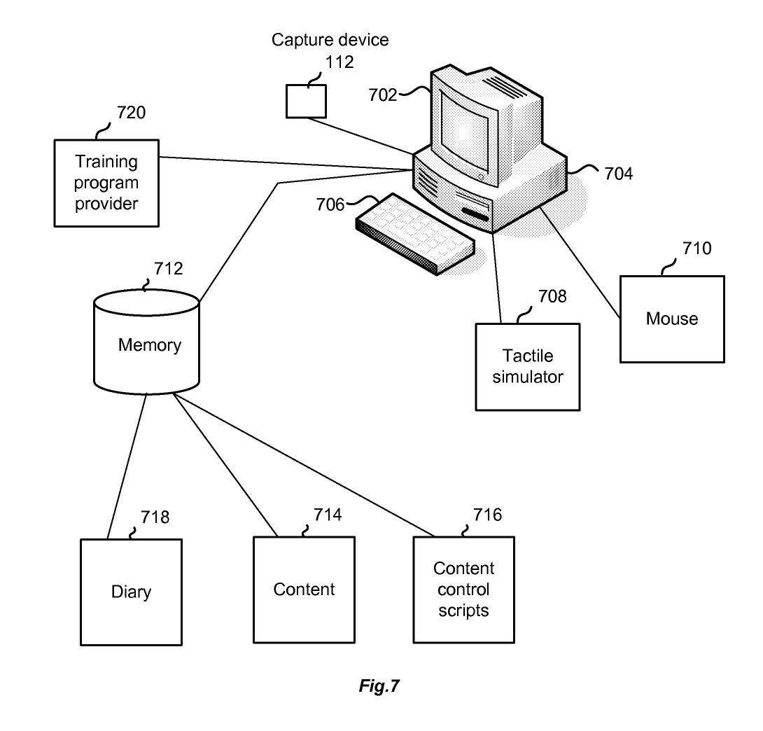

FIG. 7 shows a more detailed example of devices 102 according to one embodiment. As shown, display 102 is provided on a computer 704. A keyboard 706 allows the user to provide input to the training program. Capture device 112 is used to capture video and/or audio of the user.

A training program provider 720 is configured to administer the training program. For example, training program provider 720 performs processing as described above.

A pointing device 708 may be used by a user to provide input. For example, a mouse may be used. A tactile sensor/simulator 710 is used to determine tactile movements, such as finger strokes of varying intensities. It is also used to stimulate a trainee, such as producing a shock, vibration, warmth, physical reward, etc.

A memory 712 is used to store content 714 that includes the challenges. Also, content control scripts 716 are used to determine the sequence of challenge that should be output from content 714. A diary 718 may be used to keep track of a training program that a user performs. Also, diary 718 may include the trainee's user behavior information, performed challenges/responses, control script activity, other data captured from capture device 112, grades for responses, etc.

Although the description has been described with respect to particular embodiments thereof, these particular embodiments are merely illustrative, and not restrictive. Although training systems are discussed, it will be understood that particular embodiments may be used for purposes other than training, such as for classroom study, test taking, etc.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for providing a training program, the method comprising:
determining a content element associated with a challenge for the training program;
determining a prompt character for the content element in the training program;
outputting the challenge using the prompt character to a trainee, the challenge configured to elicit a response from the trainee;
during a response from the trainee, detecting behavior information from a recording received of the trainee; and
dynamically altering behavior of the prompt character based on the detected behavior information to provide an appearance that the prompt character is actively listening to the trainee during the response.

2. The method of claim 1, wherein the prompt character comprises an avatar or video of a user.

3. The method of claim 1, further comprising:
outputting a training program creation challenge using the prompt character;
receiving the response from a trainer;
analyzing the recorded response to determine user behavior information; and
generating the challenge for the training program based on the determined trainer behavior information.

4. The method of claim 1, wherein analyzing the recording to determine behavior information comprises analyzing gestures of the trainer in the video to determine the behavior information.

5. The method of claim 1, wherein analyzing the recording to determine behavior information comprises determining movement information from the recording of the trainee.

6. The method of claim 5, wherein analyzing the recording to determine behavior information comprises determining a subject state from the movement information.

7. The method of claim 1, further comprising:
storing the response from the trainee; and
adding information for the outputted challenge and response to the training program, wherein the information for the outputted challenge and response can be viewed in the training program.

8. The method of claim 1, further comprising outputting talking points with the challenge, the talking points indicating a portion of a response desired from the trainee.

9. The method of claim 1, further comprising:
detecting that the trainee has stopped speaking;
outputting a prompt using the prompt character intended to determine if the trainee is finished responding to the challenge; and
determining if the trainee is finished responding to the challenge based on a response or no response that is received from the trainee.

10. The method of claim 1, further comprising:
smoothing a transition from the challenge to the new challenge by adjusting a first position of the prompt character in the challenge to a second position in the new challenge while the trainee is responding to the outputted challenge.

11. The method of claim 1, further comprising:
receiving a selection of a next challenge from a trainer; and
outputting the challenge using the prompt character.

12. The method of claim 1, further comprising:
determining an emotional state that is desired from the trainee;
analyzing behavior information to determine if the emotional state is achieved; and
determining a next challenge based on driving the trainee to the desired emotional state.

13. Software encoded in one or more computer-readable media for execution by the one or more processors and when executed operable to:
determine a content element associated with a challenge for a training program;
determine a prompt character for the content element in the training program;
output the challenge using the prompt character to a trainee, the challenge configured to elicit a response from the trainee;
detect behavior information from a recording received of the trainee during a response from the trainee; and
dynamically alter behavior of the prompt character based on the detected behavior information to provide an appearance that the prompt character is actively listening to the trainee during the response.

14. The software of claim 13, wherein the prompt character comprises an avatar or video of a user.

15. The software of claim 13, wherein the software is further operable to:
output a training program creation challenge using the prompt character;
receive the response from a trainer;
analyze the recorded response to determine user behavior information; and
generate the challenge for the training program based on the determined trainer behavior information.

16. The software of claim 13, wherein software operable to analyze the recording to determine behavior information comprises software operable to analyze gestures of the trainer in the video to determine the behavior information.

17. The software of claim 13, wherein software operable to analyze the recording to determine behavior information comprises software operable to determine movement information from the recording of the trainee.

18. The software of claim 17, wherein software operable to analyze the recording to determine behavior information comprises software operable to determine a subject state from the movement information.

19. The software of claim 13, wherein the software is further operable to:
store the response from the trainee; and
add information for the outputted challenge and response to the training program, wherein the information for the outputted challenge and response can be viewed in the training program.

20. The software of claim 13, wherein the software is further operable to output talking points with the challenge, the talking points indicating a portion of a response desired from the trainee.

21. The software of claim 13, wherein the software is further operable to:
detect that the trainee has stopped speaking;
output a prompt using the prompt character intended to determine if the trainee is finished responding to the challenge; and
determine if the trainee is finished responding to the challenge based on a response or no response that is received from the trainee.

22. The software of claim 13, wherein the software is further operable to smooth a transition from the challenge to the new challenge by adjusting a first position of the prompt character in the challenge to a second position in the new challenge while the trainee is responding to the outputted challenge.

23. The software of claim 13, wherein the software is further operable to:
receive a selection of a next challenge from a trainer; and
output the challenge using the prompt character.

24. The software of claim 13, wherein the software is further operable to:
determine an emotional state that is desired from the trainee;
analyze behavior information to determine if the emotional state is achieved; and
determine a next challenge based on driving the trainee to the desired emotional state.

25. An apparatus comprising:
one or more processors; and
logic encoded in one or more tangible media for execution by the one or more processors and when executed operable to:
determine a content element associated with a challenge for a training program;
determine a prompt character for the content element in the training program;
output the challenge using the prompt character to a trainee, the challenge configured to elicit a response from the trainee;
detect behavior information from a recording received of the trainee during a response from the trainee; and
dynamically alter behavior of the prompt character based on the detected behavior information to provide an appearance that the prompt character is actively listening to the trainee during the response.
